(19) United States
(12) Patent Application Publication
(10) Pub. No.: US 2002/0032706 A1
(43) Pub. Date: Mar. 14, 2002

(54) Method and system for building internet-based applications

(76) Inventors: Jesse Perla, Toronto (CA); Vishvas Canaran, Toronto (CA); Blair Wall, Toronto (CA); Kartik Shah, Thornhill (CA); Dale Baik, Willowdale (CA)

Correspondence Address: FASKEN MARTINEAU DuMOULIN LLP, Toronto Dominion Bank Tower, Ste 4200, P.O. Box 20, Toronto-Dominion Centre, Toronto, ON, M5K 1N6, CA

(21) Appl. No.: 09/837,627

(22) Filed: Apr. 19, 2001

Related U.S. Application Data
(63) Continuation of application No. PCT/CA01/00148, filed on Jan. 31, 2001.
(63) Continuation-in-part of application No. 09/471,135, filed on Dec. 23, 1999.

(30) Foreign Application Priority Data
Jan. 31, 2000 (CA) 2,297,596
Jan. 31, 2000 (CA) 2,297,597
Jan. 31, 2000 (CA) 2,297,711

(51) Int. Cl. G06F 17/21

(52) U.S. Cl. 707/530

(57) ABSTRACT

A method for building a web-based application comprising displaying a top level menu of types, showing within each level appropriate schemas, recursively traversing the schema information to build cascading menus or toolbars, showing for each element all attributes, and building a fully qualified path or relative path based on XSL patterns when a programmer selects a level.

### The present invention relates generally to a computer-based method and systems for building World-Wide-Web- based applications.

### BACKGROUND OF THE INVENTION

The rapid growth of the Internet and more specifically the World Wide Web (WWW or Web) as a network for the delivery of applications and content, has resulted in software developers quickly beginning to shift their focus towards making the web browser a key tool to access information. This revolution has taken several stages.

Most information is available as static content, composed of a variety of media, such as text, images, audio, and video, that is described using hypertext markup language (HTML). While the WWW revolution has placed a wealth of information at the fingertips of countless people, and while HTML is a very good way of describing static documents, HTML provides no mechanism for interacting with Web pages. At present, a Web browser uses the Hypertext Transport Protocol (HTTP) to request an HTML file from a Web server for the rapid and efficient delivery of HTML documents. A Web browser is a client process (also called a “client”) running on a local or client computer that enables a user to view HTML documents. An example of a Web browser is the Internet Explorer. A Web server is a server process (also called a “server”) running on a remote or server computer that uses HTTP to serve up HTML documents and any associated files and scripts when requested by a client. To accomplish this, the user gives the Web browser a Uniform Resource Locator (URL) for an object on the Internet, for example, a data file containing information of interest. The document is referred to as a “Web page,” and the information contained in the Web page is called content. Web pages often refer to other Web pages using “hypertext link” or “hyperlinks” that include words or phrases representing the other pages in a form that gives the browser the URL for the corresponding Web page when a user selects a hyperlink.

Dynamic information retrieval such as selected information retrieved from databases commonly implemented through the use of the Common Gateway Interface (CGI). While CGI allows specifically requested information to be accessed from databases across the Internet, CGI has very limited capabilities.

An alternative to using separate CGI scripts to define content is a template-based HTML that actually embeds a request for the dynamic data within the HTML file itself. When a specific page is requested, a pre-processor scans the file for proprietary tags that are then translated into final HTML based on the request. The final HTML is then passed back to the server and on to the browser for the user to view on their computer terminal. While the examples given have been explained in the context of HTML. Templates may be created with any Standard Generalized Markup Language (SGML) based markup language, such as Handheld Device Markup language (HDML). In fact templates can be created with any markup language or text, in fact it is not limited to SGML based languages but rather to MIME types HDML, is a markup language designed and developed by AT&T and Unwired Planet, Inc. to allow handheld devices, such as phones, access to the resources of the Internet. The specifics of the language are disclosed in “HDML Language Reference, Version 1.0,” Unwired Planet, Inc., July 1996, and herein incorporated by reference Templates with the markup in it and some scripting to execute the data and the display of the pages are separated to make generating an application a process of using an HTML template with script embedded to generate the resulting page. Examples of this technology are Active Server Pages (ASP) from Microsoft, PHP from the Apache organization or Java Server Pages (JSP) from Sun. Often these have been developed in a three-tier physical and/or logical implementation in an attempt to separate the display from the data logic.

As the HTTP based technology has matured, these have tended to move towards the clear separation of the HTML template from the underlying data. Recently there have been several other key advancements.

A subset and simplification of SGML, the extensible Markup Language (XML) has evolved as a standard meta-data format in order to simplify the exchange of data. The eXtensible Stylesheet Language (XSL) has evolved as the standard way to define stylesheets that accept XML as input; and Non-HTML browsers accessing data over HTTP are becoming common and in the next few years will become more common than browsers on desktop computers.

One example is the Handheld Device Markup Language (HDML) from Phone.com and its evolution the Wireless Markup Language (WML) from the WAP Forum. The wireless networks around the world are converging to the Internet to support this trend. Universal Resource Locators (URL) now point to anything on the Internet and can be used by devices ranging from Mobile Phones to Integrated Voice Response (IVR) servers using VoiceXML or VoXML (www.voxml.com).

As more content publishers and commercial interests deliver rich data in XML, the need for presentation technology increases in both scale and functionality. XSL meets the more complex, structural formatting demands that XML document authors have. On the other hand XSL Transformations known as XSLT makes it possible for one XML document to be transformed into another according to an XSL Style sheet. More generally however, XSLT can turn XML into anything textual, regardless of how well-formed it is, for HTML. As part of the document transformation, XSLT uses Xpath (XML Path language) to address parts of an XML document that an author wishes to transform. XPath is also used by another XML technology, XPointer, to specify locations in an XML document.

However XSLT has also not addressed the problem of allowing the development applications that are easily decomposed, portable and easily distributed, while still efficiently serving a multitude of different devices. Applications are generally comprised of a plurality of forms, which are connected to achieve a desired flow. It is desirable to allow developers the ability to reuse parts of application, however with the current markup language technologies it is difficult to achieve this without recreating parts if not substantially all of the application. This problem is further compounded with the need to accommodate different device. At present stylesheets are still tightly linked to the flow of an application.

A further problem with current web-based applications, arises from the current tools and techniques used to develop these applications. In general, an application is an autonomous collection of forms defined by a flow and which may include connectors to databases, sequences, or functions, and data. Typically, mark-up based applications are accessible through web service and have been designed as monolithic, spaghetti code. It has been observed that while individual programming languages provide good constructs for management of reusable libraries, the translation of such to the design of web applications has been sadly lacking.

Web-based applications use HTTP as a protocol for passing data between forms or pages. HTTP provides several methods to pass data including GET parameters, POST parameters and cookies. Regardless of the programming environment, that is, whether it is ASP, Java pages, PHM, or Java Servlets, a common problem with designing web applications is that developers use the methods inconsistently in an application. It has been observed that there is no standard method to provide meta-information about at least the type and purpose of variables used on the form. These methods or calls are stateless across HTTP sessions on the web.

Thus there is a need to for a system and method which enables programmers to visually create style sheets from many input schemes.

### SUMMARY OF THE INVENTION

An advantage of the present invention is derived from the observation that data is separated from a stylesheet and from program flow. The separation of the flow and form meta-data allows for a separation of data from stylesheets. Otherwise, the stylesheet must maintain maps of where it receives its data from as well as the relationships to different forms. The invention solves this problem by the creation of a schema, which provides all of the flow and meta information in an external file.

### BRIEF DESCRIPTION OF DRAWINGS

Embodiments of the invention will now be described by way of example only, with reference to the accompanying drawings in which:

FIG. 1 is a block diagram depicting a wireless network system;

FIG. 2 is a block diagram depicting the major components in a system according to an embodiment of the present invention;

FIG. 3 is a schematic diagram of the application element structure in a Hosted Markup Language application;

FIG. 4 is a schematic representation of the form element structure in the Hosted Markup Language;

FIG. 5 is a schematic representation showing the structure of the Runtime Markup Language;

FIG. 6 is a block diagram of the high level components for processing of HML to generate RML;

FIG. 7 is a block diagram showing the flow for the execution of components described in FIG. 6;

FIG. 8(a) is a schematic diagram of a Bank account query application;

FIGS. 8(b)-(d) is a schematic representation of an HML file for the Bank account query application;

FIGS. 9(a), (b) and (c) are mark-up language representations of a sample generated RML for the Bank account query application;

FIGS. 10(a) and (b) are mark-up language representations of an XSL style sheet for the Bank account query application; and

FIG. 11 is a mark-up language representation of a WML document returned to a device in the Bank account query application;

FIG. 12 shows a screen capture of a design tool, selecting forms input variables;

FIG. 13 shows a screen capture of the design tool screen for selecting a list test box;

FIGS. 14 and 15 show screen captures of the design tool screen for specifying form data; and

FIG. 16 is a schematic diagram of the design tool screen showing an output.

### DETAILED DESCRIPTION OF THE PREFERRED EMBODIMENTS

In the following description, the same reference numerals will be used in the drawings to refer to the same or like parts.

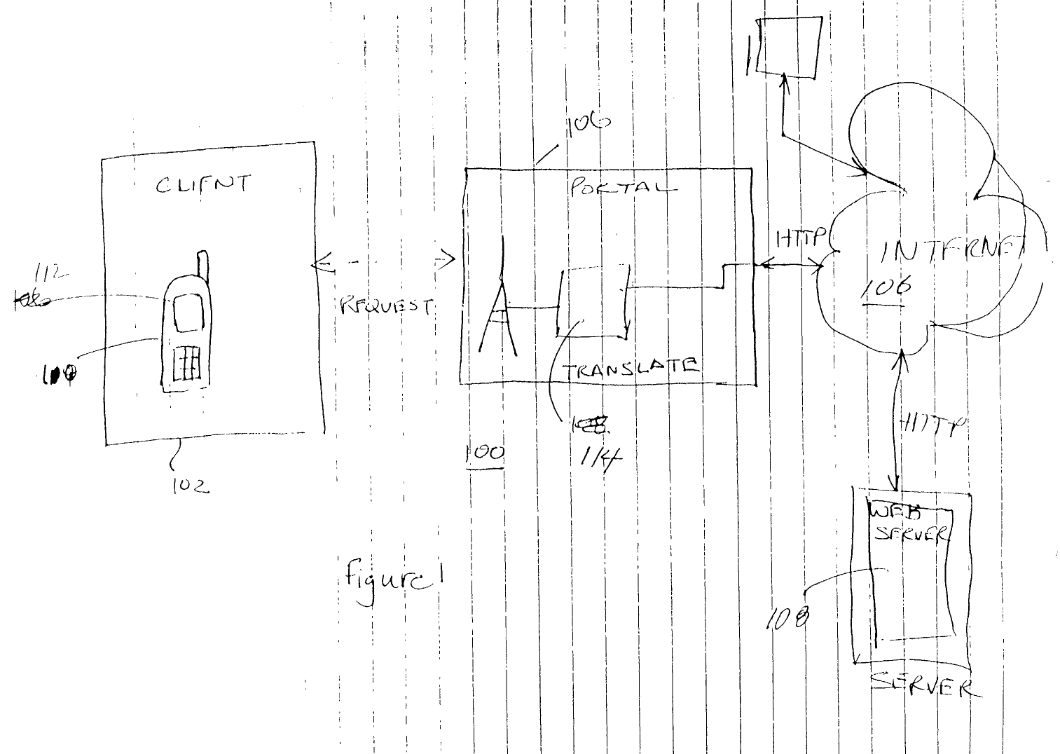

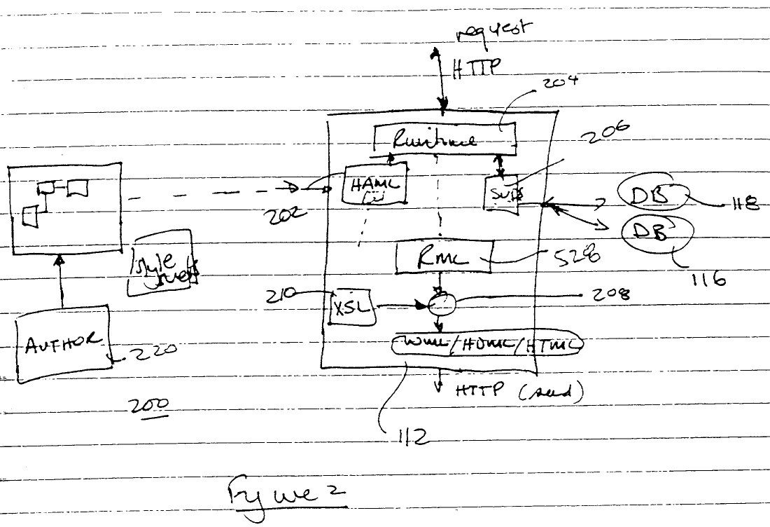

Referring to FIG. 1, a block diagram of a data communication system in which the present invention may be used is shown generally by numeral 100. The present invention is described in the context of the Internet, wherein client devices 102 make requests, through a portal or gateway 104, over the Internet 106 to web servers 108. Web servers 108 are capable of communicating via HTTP, HTTP/S or similar and providing information formatted with HTML codes the client 102 which may be capable of interpreting such codes or may rely on a translation by the portal 106. In this embodiment, HTML is described as one example and the gateway may or may not translate.

In fact, a gateway is not necessary for the majority of connecting devices. In a particular instance, the client 102 may be a cell phone device 110 having a screen display 112, the portal 106 may be a cell phone network 114 that routes calls and data transfers from the telephone 110 to a PSTN or to other cellular phone networks. The cell phone network 114 is also capable of routing data transfers between the telephone 110 and the Internet 106. The communication between the cell phone network 114 and the Internet 106 is via the HTTP protocol, or WAP which is more likely for a phone network, the gateways typically translate the call to HTTP, which is well known in the art. Furthermore, it is assumed that the telephone 110 and the cell phone network implement the appropriate protocols for a web browser or similar that can retrieve data over the internet and translate the data file for display on the display 112.

The system 100 also includes at least one host server or web server, which is a remote computer system 112 which is accessible over the internet to the cell phone network and the telephone 102. The web server 108 includes data files written in a mark up language, which may be specifically formatted for the screen display 104 of the telephone 102. This language could comprise a standard text based language similar to HTML or could include WML, HDML, or other specifically designed mark up language or simply text to send to a phone 110.

The web server 108 may also include an application which is run on the server and is accessible by the device 110 specifying a URL or similar of the application. At present, the system 100 operates by the device 110 transmitting a request to the cell phone network 114. The cell phone network 114 translates the request and generates a corresponding HTTP formatted message, which includes the requested URL. The HTTP request message is transmitted to the web server 108 where a data file is located. The data file must be formatted to be compatible to the display capabilities of the telephone 102. The web server calls a process, which invokes an XSL stylesheet interpreter with the appropriate HML and the stylesheet to create the formatted markup of the appropriate MIME type. In some cases both the XML input and the XSL stylesheet may be provided to the client browser to interpret if the client has an XSL built.

By way of background, Extensible Markup Language, abbreviated XML, describes a class of data objects called dt-xml-doc XML documents and partially describes the behavior of computer programs which process them. XML is an application profile or restricted form of SGML, the Standard Generalized Markup Language. By construction, XML documents are conforming SGML documents.

XML documents are made up of storage units called entities, which contain either parsed or unparsed data. Parsed data is made up of characters some of which form character data dt-chardata, and some of which form markup. Markup encodes a description of the document's storage layout and logical structure. XML provides a mechanism to impose constraints on the storage layout and logical structure.

A software module called an XML processor is used to read XML documents and provide access to their content and structure. It is assumed that an XML processor is doing its work on behalf of another module, called the application, which resides on the web server 108.

Each XML document has both a logical and a physical structure. Physically, the document is composed of the units called entities. An entity may refer to other entities to cause their inclusion in the document. A document begins in a “root” or document entity. Logically, the document is composed of declarations, elements, comments, character references, and processing instructions, all of which are indicated in the document by explicit markup. The logical and physical structures must nest properly.

Each XML Document contains one or more elements, the boundaries of which are either delimited by start-tags and end-tags. Each element has a type, identified by name, sometimes called its “generic identifier” (GI), and may have a set of attribute specifications. Each attribute specification has a name and a value.

Style Sheets can be associated with an XML Document by using a processing instruction whose target is xml-stylesheet. This processing instruction follows the behavior of the HTML. The xml-stylesheet processing instruction is parsed in the same way as a start-tag, with the exception that entities other than predefined entities must not be referenced.

XSL is a language for expressing stylesheets. A stylesheet contains a set of template rules. A template rule has two parts: a pattern, which is matched against nodes in the source tree and a template, which can be instantiated to form part of the result tree. This allows a stylesheet to be applicable to a wide class of documents that have similar source tree structures.

Each stylesheet describes rules for presenting a class of XML source documents. An XSL stylesheet processor accepts a document or data in XML and an XSL stylesheet and produces the presentation of that XML source content as intended by the stylesheet. There are two sub-processes to this presentation process: first, constructing a result tree from the XML source tree and second, interpreting the result tree to produce a formatted presentation on a display, on paper, in speech or onto other media. The first (sub-)process is called tree transformation and the second (sub-)process is called formatting. The process of formatting is performed by the formatter.

As described above, the prior art technique is tedious and not easily adaptable to different devices and applications and a plurality of user languages. One embodiment of the present invention is thus based on the observation that a solution to the above problem is a separation of data from style sheets which in turn is separated from program flow. Although it has been recognized that the characteristics of a display needs to be separated from the data, in practice current solutions have failed to understand that the separation of the flow and form metadata is necessary before data can be separated from the style sheets. In other words, at present, style sheets must maintain maps of its data sources and its relationships to different forms. Accordingly, the present invention solves this problem by providing a hosted mark up language (HML) for providing flow and meta information in an external file.

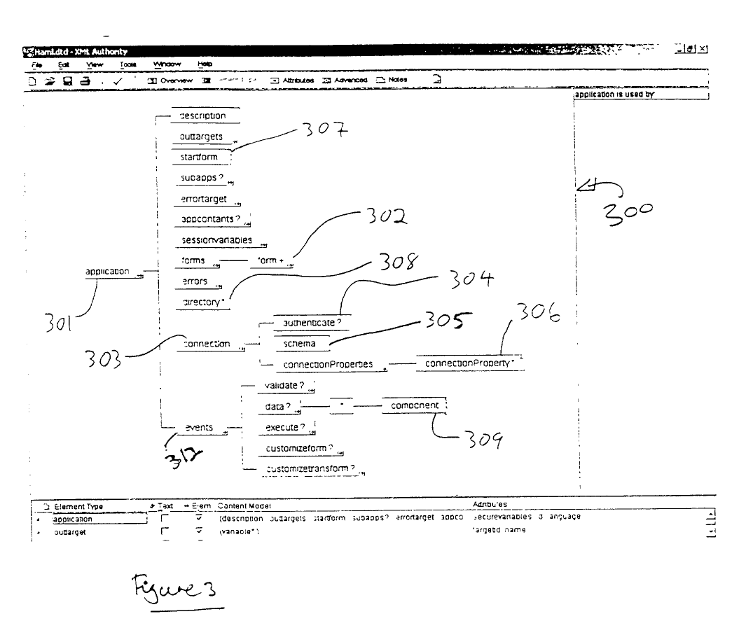

Thus turning to FIG. 2, there is shown at numeral 200, the general components of a system, according to an embodiment of the present invention, for providing a unified data transfer between different devices (clients) and a server over an HTTP based network. The system 200 includes a hosted mark up language (HML) file or application 202 written in accordance with the present invention and residing on the web server 108, a plurality of style sheets 210 and a run-time program or processor 204 for processing the HML application 202 in response to an HTTP message corresponding to a request received from the client device 110. The HML application 202 includes a plurality of forms and pointers to external data sources. The processor 204 includes a data server 206 for retrieving data from one or more databases 216, 218 in accordance with the instructions in the HML, an XSL processor 208, and the plurality of XSL style sheets 210.

A further embodiment of the system 200 includes a visual authoring tool 220 for providing a development framework for visually connecting forms defining a look, feel and flow of an application and for generating from the visual layout the HML application 202.

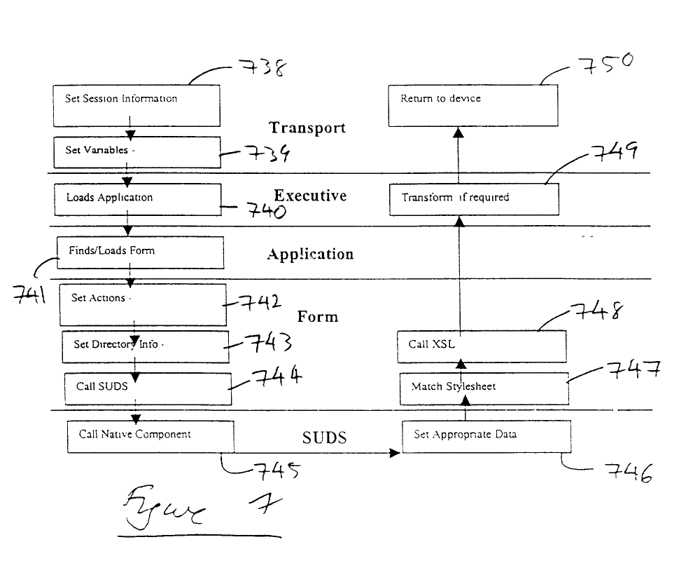

In general, the runtime 204 is called by a device 102 in a manner as described with reference to FIG. 1, which connects to the server 112 using HTTP. Based on the URL that is requested and the type of device making the request, the runtime 204 determines an appropriate form to use. The runtime calls a data server component 206 to obtain data for the URL from one or more databases 118 and 116. The data server 206 retrieves the appropriate data into XML, and forwards this to the runtime which in turn adds runtime information and directory information to the data XML, the data structure that is built or populated by the HML processor is termed RML, the structure of which will be described with reference to FIG. 5 later. The runtime calls the XSL processor 208 with the RML and an appropriate style sheet 210 for the form after the runtime 204 calls the XSL processor 208, the XSL processor generates a file that depends on how the XSL stylesheet was written. In particular a stylesheet is written for a particular MIME content-type.(notice that in the description of the RML stylesheet we have a content-type attribute) For example if it is HTML with embedded XSL instructions then the processor will generate HTML, if it is a simple test file with embedded XSL instructions then simple text will be generated. Thus if the requesting device has a specific mark-up, the runtime 204 returns the appropriate mark-up file. However, if the device does not have the specific mark-up, the run time transforms the generated WML to the appropriate markup and sends it back to the device.

The detailed description of the operation and interconnection of the various components will be described in greater detail in the following paragraphs.

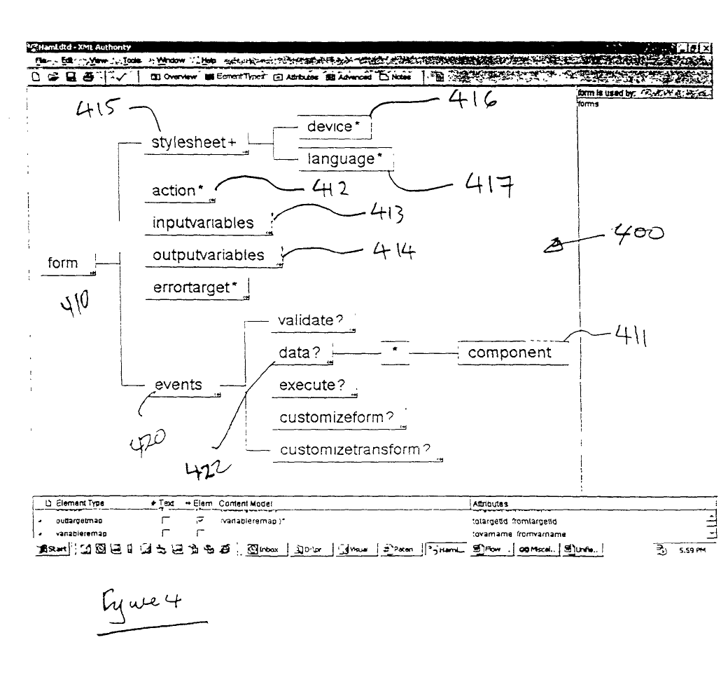

Referring to FIG. 3, there is shown at numeral 300 a defined schema or data structure for the elements contained in an HML application. All of the elements are described as XML based schemas including attributes and elements. The first element of the HML 300 is an

Application Element 301 which is a root element having Key Attributes:

“id” which is a unique identifier for the application;

“language” which describes which variable to extract the user language from.

Children Elements:

Startform 307, containing an id attribute which points to a Form's targetid within the application;

forms collection 302 having Multiple Form elements;

Multiple Connection elements 303;

A Data element contained within an events element which contains multiple component elements 309;

Multiple Directory elements 308 containing information to connect to directory type data. Contain a name attribute.

Connection Element 303

Defines a connection to an outside source of data.

Key Attributes:

“connectionid” which is a unique identifier for the connection;

“type” which determines how to get the data;

“server” which gives the IP address to access the server;

Children Elements:

Authenticate 304

Schema element 305 containing a URL attribute to access the schema information;

Multiple connectionproperty elements 306 providing name/value pairs as inputs to the component defined by the “type” attribute.

Component Element 311

Defines an external set of data. Since this is underneath the application it will be passed to all forms.

Key Attributes:

“connectionid” points to a connection element 303;

Authenticate Element 304 defines how to authenticate against an external data source;

Key Attributes:

“user” provides the username for authentication;

“password” provides the external password;

The text of the authenticate element can contact CData or any other information that is used by the data server 206 to authenticate. Examples include certificates, etc.

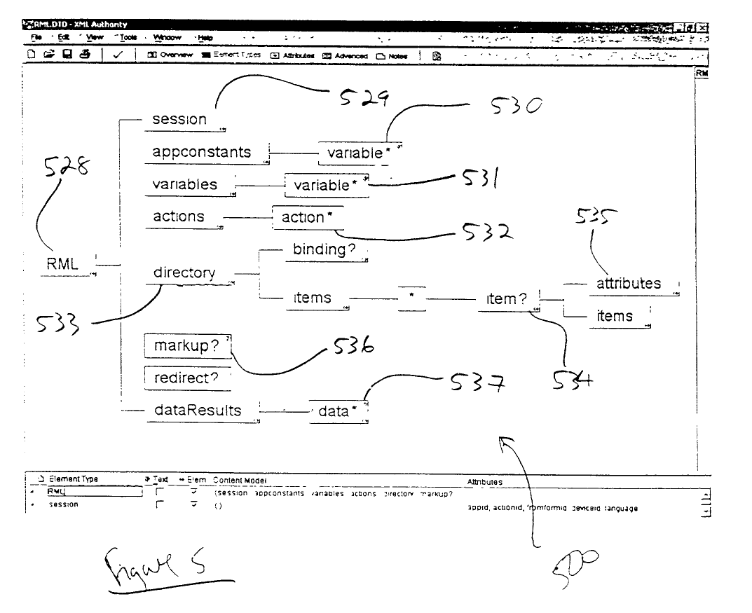

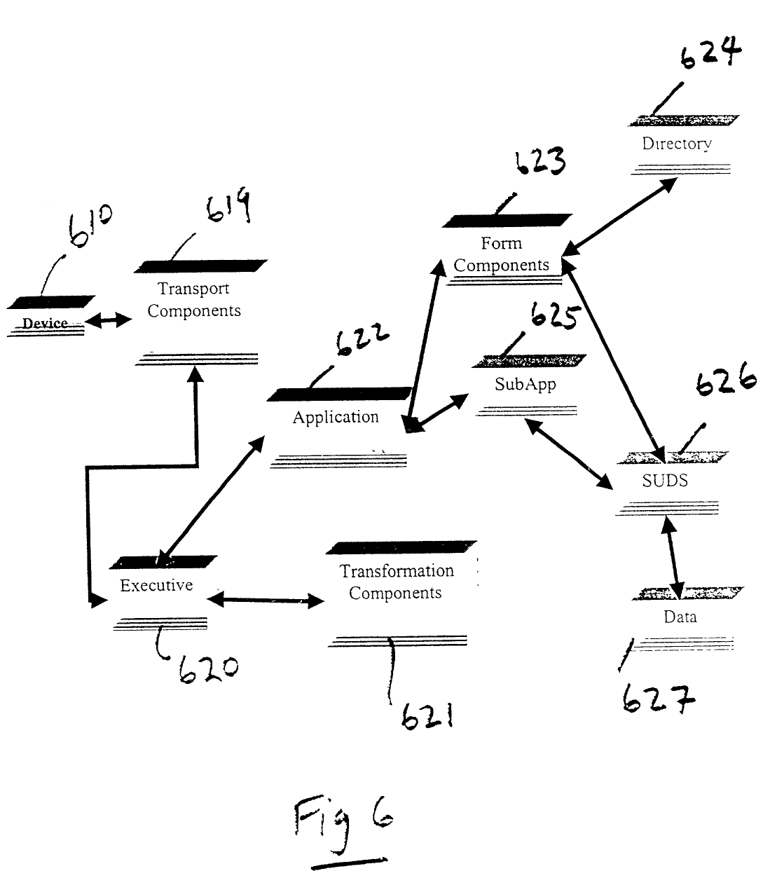

Form Element 302 which is shown in detail in FIG. 4 generally by numeral 400 This element defines a form and is contained under the forms collection of the application.

Key Attributes:

“targetid” which is a unique identifier for the form “language” which describes which variable to extract the user language from.

Children Elements:

Multiple Stylesheet 415 elements

Multiple action 412, input variables 413, and output variables 414 which define the flow and application reuse.

A Data element 422 ontained within an events element 420 which contains multiple Component elements 411;

Stylesheet Element 415

Defines a potentially matched stylesheet for a form

Key Attributes:

“URL” defines an external link to the actual XSL stylesheet file 210 or instead of having an external XSL file 210, the text of the stylesheet element can contain an embedded CData containing the stylesheet contents;

“contenttype” determines the MIME type of the generated XSL stylesheet file. Examples include “text/xml”, “text/plain”, and “text/html”.

Children Elements:

Multiple Device elements 416. The device only has a single attribute “name”;

Multiple Language elements 417. The language element only has a single attribute “language”;

Component Element 411

Defines an external set of data. Since this is underneath the form 302 it will only be passed into stylesheets on this form, otherwise it is identical to the application level component element 309;

Key Attributes:

“connectionid” points to a connection element 303

As described earlier the runtime processor processes the HML and creates and populates a resulting RML data structure. Referring to FIG. 5, the data structure or schema of the RML according to an embodiment of the invention is shown generally at numeral 500. The RML schema is comprised of:

RML element 528—the root element;

Children Elements:

Session element 529, Appconstants 530, and Actions defining flow 532 Multiple variable elements 531 underneath the variables collection. These just have a name attribute and the text of which contains the value.

Multiple directory element 533 containing data from directory connections 308

Multiple data elements 537 containing data from data connections 303.

Session Element 529 contains information from the user request.

Key Attributes:

“appid” points to the id attribute of the Application element 307;

“fromformid” points to the targetid attribute of a form element 302;

“actionid” is the name of the action 412 defined on the form 402 and is used for flow;

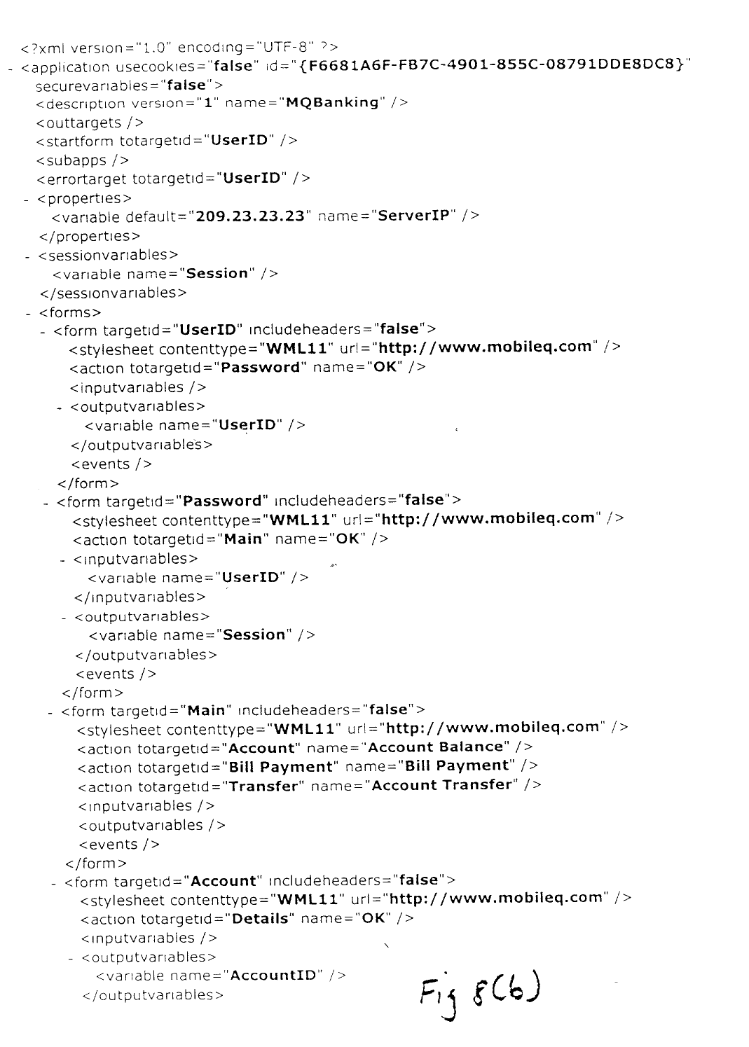

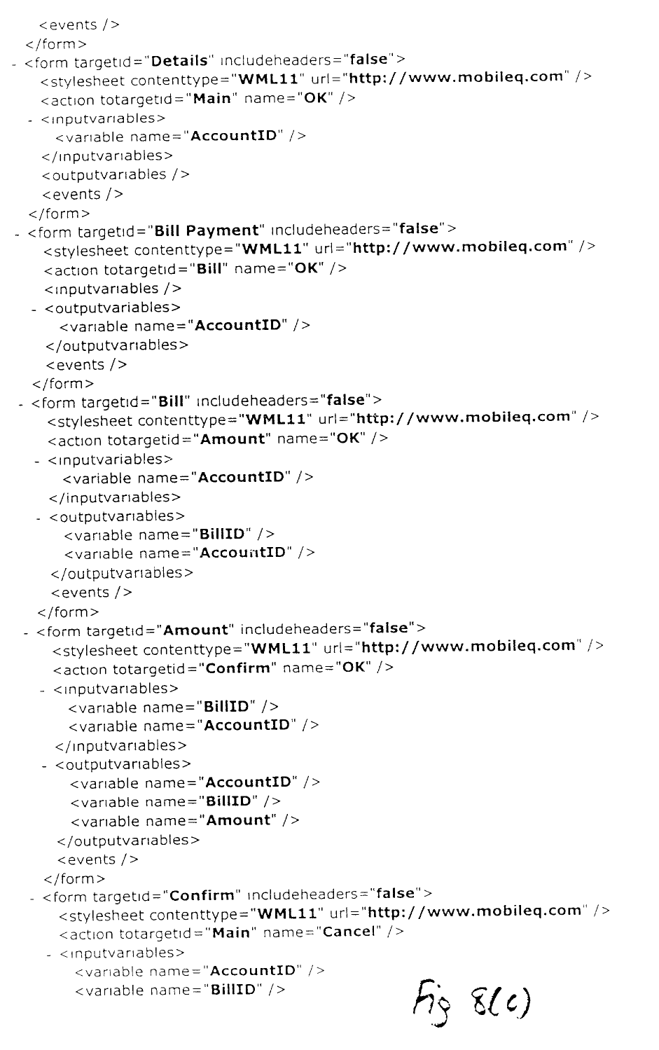

“deviceid” stores the name of the device 110 and links to a value in a device lookup table 553 described later with reference to FIG. 7;

Directory Element 533 is a container for the data from a directory connection. Primary difference between this and the Data element 537 is that the directory connections always have a consistent hierarchical schema.

Key Attributes:

“name” uniquely identifies the directory input. It will be the name attribute from one of the Directory elements in the application 308.

Children Elements:

Contains multiple Item elements 534, which in turn can have its own item elements and attribute elements 535. This defines an arbitrarily deep hierarchy of directory/profiling type data.

Data Element 533

The Data element is a container for the data from a data connection. The key is that it provides a way to store arbitrary XML document fragments within the RML.

Key Attributes:

“name” uniquely identifies the data. It will be the component id from one of the application 309 or form components 411.

Children elements:

It can contain any hierarchy and elements that is consistent with the schema defined in 305 for its components, connections, schema.

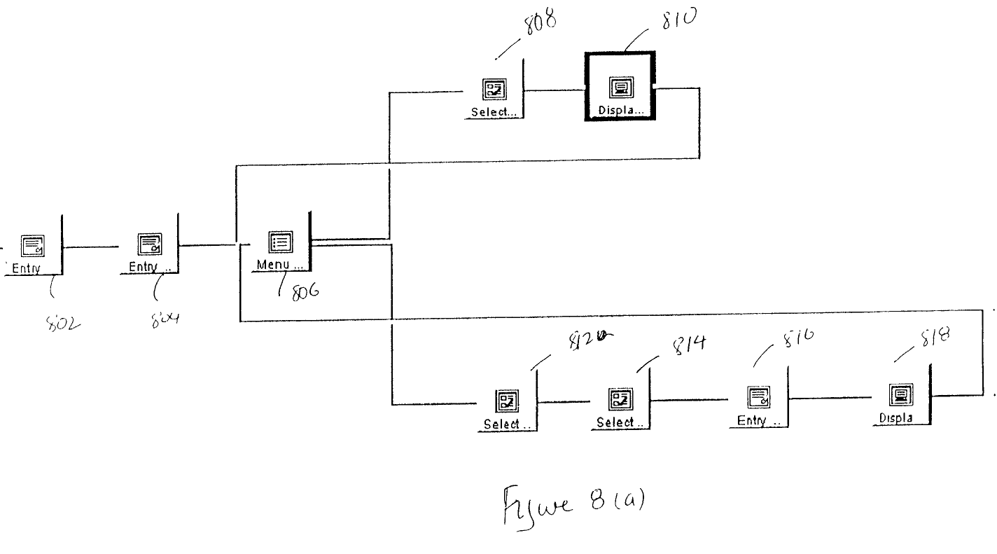

Referring to FIG. 6, there is shown generally at numeral 600, a schematic diagram of the subcomponents of the runtime processor 204. The runtime processor 204 includes transport components 619, an executive 620, transformation components 621, and form components 623. The operation of the runtime processor 204 to generate the RML is now described by referring to FIG. 7. In the following description the term “set” refer to the process of setting or populating pieces of the RML document. The process is described by the sequence of blocks 738 to 748. Block 738 is the entry into the processing.

At step 738, the transport component receives a call from the requesting device generated through some sort of URL. The transport component 619 processes the incoming HTTP request and extracts amongst others the following values, which are used to populate the appropriate sections of the RML structure 500. The values it extracts are:

The value of the “_SQAPPID” variable in query string/post/cookie is placed into the session element 529 “appid” attribute;

The value of the “_SQFORMID” variable in query string/post/cookie is placed into the session element 29 “fromformid” attribute;

The value of the “_ACTIONID” variable in query string/post/cookie is placed into the session element 29 “actionid” attribute; and

“_SQFORMID” variables on the query string are extracted as values and placed into the session element 29 “fromformid”.

The transport component 719 is also responsible for extracting and determining the “device” attribute within the session element 529. The query string may provide the device attribute directly as a variable called “device” which is directly placed into the “device” attribute of the session element 529 of the RML structure. If the device variable-is not set, then a look-up table may be used to determine this value by using the “HTTP_User_Agent” header. A look-up table for determining the device variable is shown below in Table I:

TABLE I

| UserAgent | UASubstring | Device | ContentType |
|---|---|---|---|
| UP.Browser/3.1-UPG1 | UP.Browser | UPBrowser | text/hdml |
| UP.Link/3.2 | | | |
| Mozilla/4.0 (compatible; | Mozilla | HTMLDefault | text/html |
| MSIE 5.01; Windows | | | |
| NT 5.0) | | | |

While the UserAgent information is provided in every HTTP request, there is no consistency in the format of the strings between various browsers. Since the system needs to determine the type of the connecting device, a method is necessary to map the value in the string to a name for a device.

The lookup table I can be stored directly in the HML file, in a database, or in a registry depending on the platform for implementation. The key is that it is easily editable and flexible. The first column in the table is not stored in the actual table but represents real examples of connecting user agent strings for the UP Emulator's HDML browser and Microsoft's Internet Explorer HTML browser respectively. The user agent string is matched to rows in the lookup table attempting to do a UAsubstring search of column two within the incoming HTTP_USER_AGENT column one. When a match is found, the matched device name from column three is placed into the “device” attribute of the session element 529. If no match is found then a default text “HTMLDefault” is placed into the “device” attribute of the session element 529.

At Step 739 which is similar to Step 738 the transport component 619 extracts variables form the HTTP headers and the query string/post/cookies. However, instead of filling in the Session element 529 it fills in the Variable elements underneath the variables element 531 including:

All variables on the query string, post, or in cookies. For example, “http://myserver/transport.asp?var1=a&var2=b”would place two new input variables 31 with name attributes of “var-1” and “var2” and values of “a” and “b”.

All Custom HTTP Headers. An example of a custom header from a UP.Link gateway from Phone.com is: “HTTP_X_UP_SUBNO” and the value might be: “919799575-146551_up.mytelco.ca”. This would add in a input variable 31 with a name attribute of “HTTP_X_UP_SUBNO” and a value of “919799575-146551_up.mytelco.ca”.

While the described implementation of the Transport 619 relies on data accessible from HTTP it is not necessary. As long as name/value pairs can be extracted from the incoming protocol the transport can fill in the appropriate RML elements. Similar variations include a Transport 619 designed to accept Simple Message Transport Protocol(SMTP) or Wireless Application Protocol(WAP) requests.

In Step 740 the Executive 620 is called by the Transport 619. The Executive 620 uses the “appid” attribute of the Session element 529 to create the application component 622, shown in FIG. 6, based on a match with the “id” attribute of the Application element 301.

In Step 741 the Application 622 uses the “fromformid” and the “actionid” of the Session element 529 to find the appropriate form object to create. It does this by looking up the form 302 within its application 301 and matching the “targetid” of the form to the “fromformid”. It then looks at the action elements 412 within the particular form 410 to find the action whose “actionid” matches the “actionid” of the Session 529. From this action it can find the “targetid” of the form element 302 within the application 301. It uses this form identifier to create the appropriate form component 623, shown in FIG. 6.

In Step 742 the Form component 623 traverses the sub-elements of the Form 410 to set to Action 532 of the RML structure 500.

In Step 743 the form component 623 uses the directory connection information for the application 301 defined in 308 to call the appropriate directory component 624, shown in FIG. 6, and populate the directory REAL contained in 533. The details of executing the directory components are described in a separate patent application.

In Step 744 the Form 623 creates a SOAP based data server components 626 with information to create components to generate arbitrary XML data. The data server components 626 are called for each component in the application level component 309 and the form level components 11. It passes “connectionid” attribute for the data server component 626.

In Step 45 the data server component 626 uses the “connectionid” attribute passed in to create and execute the appropriate components. The “type” attribute of the connection 303 is the name of the class which is the handler for this particular type of connection. Examples include “MQProvider.COM”, “MQProvider.Java”, “MQProvider.URL”, and “MQProvider.ODBC”. The data server component creates 626 this class and passes in the complete RML tree 528, the authentication information 304, and all of the connection properties 306. The implementation of the created component uses all of these values to get data from the source defined by its components.

The implementation of these components from data server components 626 is intended to be as general as possible and the only assumption to the functionality of this plugin is that it takes values as defined in Step 745 and returns back XML data that can be validated by the schema 305 for the connection. The connectionproperty elements 306 are used internally to the component to define where and how the execution occurs. Example implementations include:

The “MQProvider.COM” requires a connection property 306 called “progid”. It uses the Microsoft COM library to create the object defined in “progid”. It then calls a defined interface on the component and passes in the RML root 528 as an input. It directly takes the output of the component as XML to pass to the next step.

The “MQProvider.URL” implementation might require a connection property 306 called “path”. It uses the “server” attribute of the connection 303 and this path to construct a complete URL. An example might be: “http://myserver/mypage.xml”. It then uses internet functions to access this page over the web. The only assumption is that the page returns data in XML which it directly passes on to the next step.

In Step 746 for each of the component “connectionid” attributes, the data server component 626 creates a data element 537 in the RML 500 and sets the “name” attribute is equal to the “connectionid” attribute. It then puts the XML data created in Step 745 as sub-elements underneath this data node.

In Step 747 the Form components 623 uses the value in the “language” attribute of the application 301 to find the name of the variable to find the user's preferred language in. It does a lookup in the variables 531 and places the value into the “language” attribute of the session element 529. The rest of step 747 attempts to match the appropriate stylesheet within the form based on the “device” 416 and “language” attributes 417 of the Session element 529. The matching process begins by enumerating the stylesheet elements 415 for the form 410 then the process continues as:

Look for an exact match of “language” and “device” attributes in the session 529 to the “name” attributes of the language and device elements 416 and 417 within each stylesheet 415;

If no match is found then it changes the language to “default” and attempts the same matching; and

If no match is found then it changes the device to “HTMLDefault” and attempts the same matching. This is guaranteed to have a match.

In Step 748 the Form component 623 takes the stylesheet element 415 returned from the previous step and uses the URL attribute or the text within the element to get an actual XSL file. It then calls the XSL interpreter 208 with this file and the complete RML 528 as the input. The specific XSL interpreter does not need to be defined since all available interpreters generate some sort of file which represents the file to be sent back to the user.

In Step 749 the Executive 620 decides if a transformation component 621 is required. It does this by looking at the “contenttype” (column four of table I) of the appropriate “device” (column three of Table I) end comparing it to the “contenttype” of the stylesheet 415. If the values are the same then no transformation is required. If they are different then it uses an internal table to determine which transformation component 621 to call. After calling the transformation the resulting form will definitely have the contenttype (column four of Table I) expected by the device (column one of Table I).

In Step 50 the Transport component 619 returns back the generated form to the device 110 while setting the “contenttype” of the returned file to be consistent with device column of Table I.

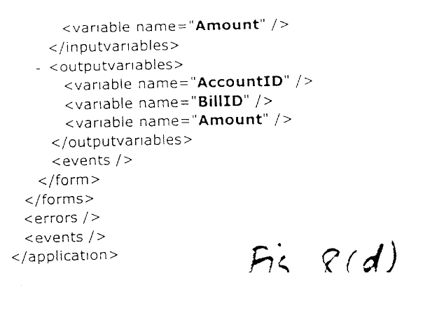

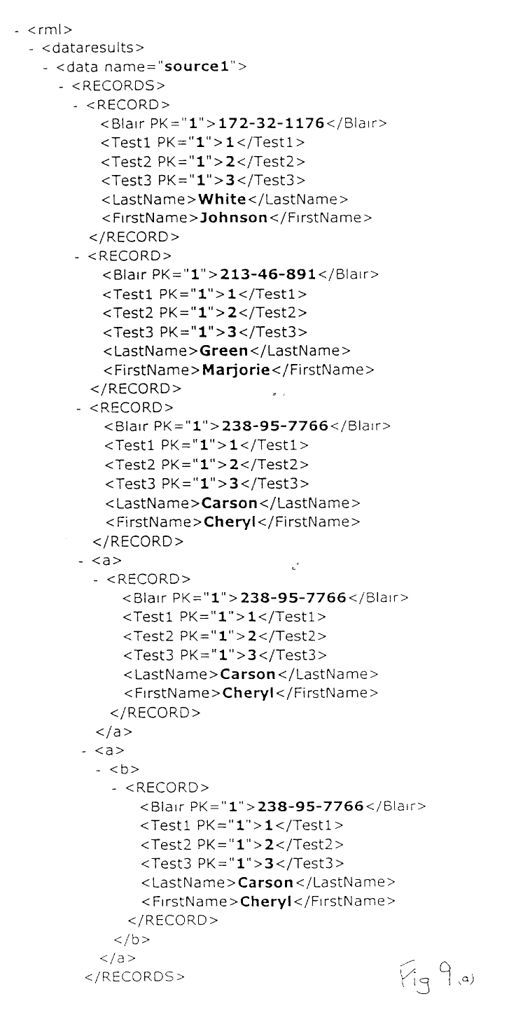

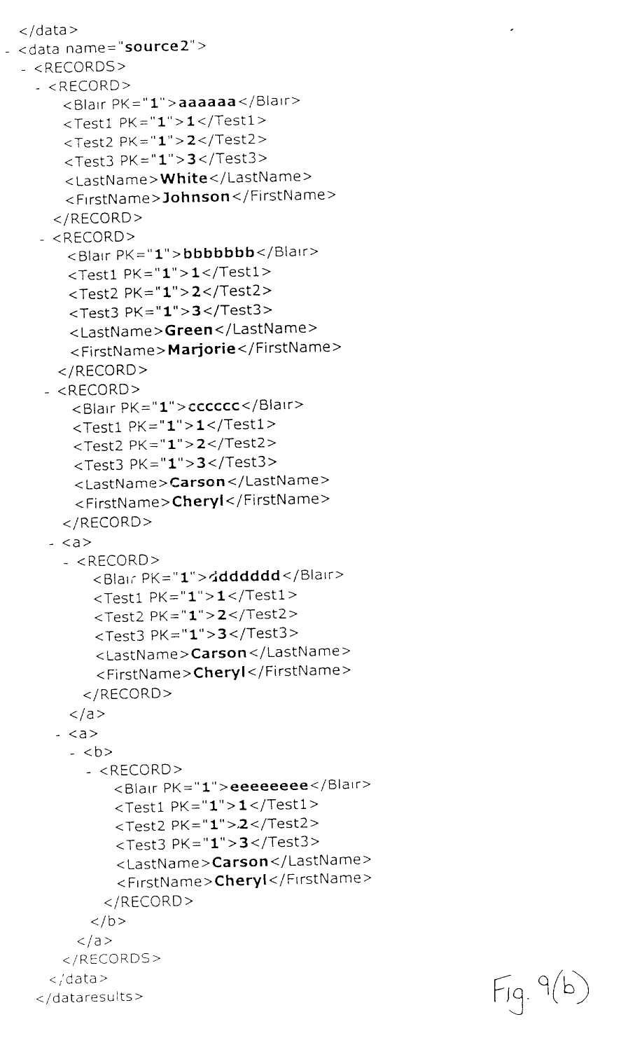

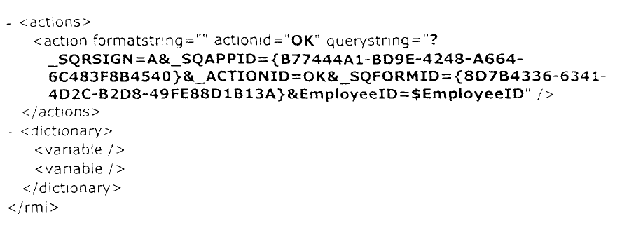

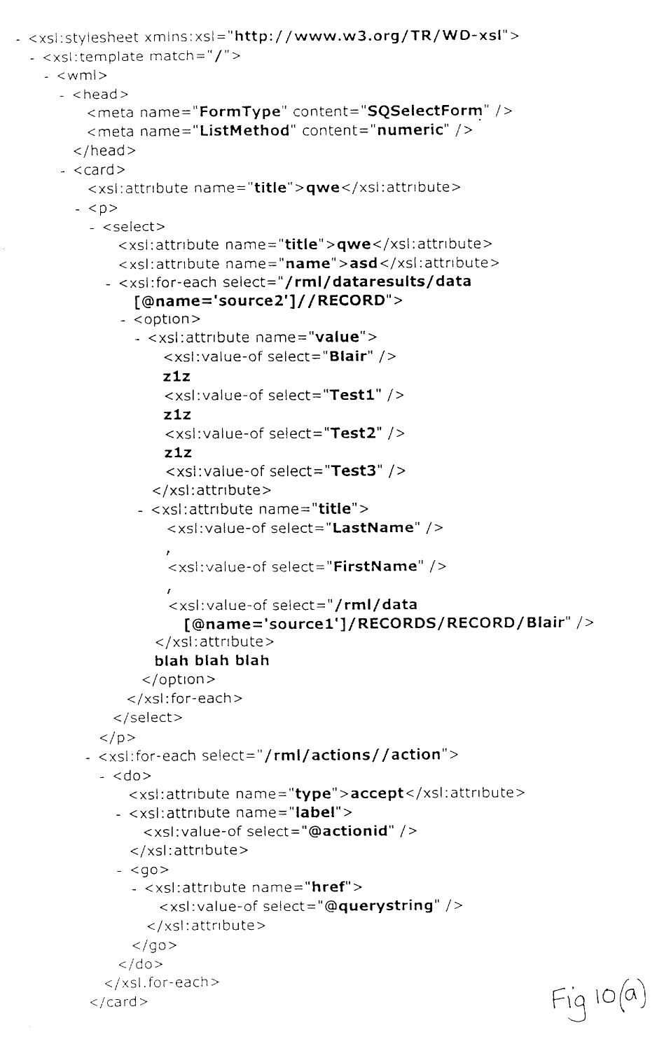

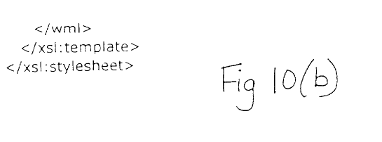

Referring now to FIGS. 8, 9, 10 and 11, there is shown an application of the present invention to an English language WML enabled phone accessing a bank account query application. The application, which is specified in the HML code shown schematically in FIGS. 8(a), is comprised of a sequence of forms 802 to 818. The generated HML is shown in FIG. 8(b)-(d).

Although the above described with respect to client-server, where client is a mobile device. The invention is equally applicable to a situation where a client does not have a browser such as in a business to business scenario. For example such as is executing an order from a supplier (server) to a customer (client). Both parties may be server computers wherein information is requested by a first server (client) from a second server. The second server (server) retrieves and formats the information for direct storage in the first server's database. The invention is also applicable to situations where the forms are not displayable. In a further embodiment the invention may be used in an Intranet. This application will not be described further as its implementation is self-evident from the associated figures.

Although aspects of the invention have been described with reference to a specific schema, other schemas may also be used with the provision of an appropriate schema processor.

In a still further aspect of the invention there is provided a system and method for automating the building of these web-based applications.

Each form will dynamically generate the XSL required to describe itself. This would happen at design-time and would be stored along with the form for runtime usage. Each of the forms has a property page that would help the user generate the XSL. The user has the option of modifying this XSL manually, as needed. The generated XSL would be displayed on a separate property page. This page would be common to all the forms.

The property pages behave like a Wizard. In other words, the property pages would only generate the XSL. If the user decides to modify the XSL, the property page values would not be changed accordingly to reflect these changes. Hence, the next time the user uses the form's property pages to configure it, the XSL will be re-generated and the customizations will be over-written.

The property page contains an edit window to display the XSL String. The user does have the option of modifying the XSL manually. The XSL String from the property page would be persisted to disk within the form object. So, the user can put in any customizations they want to the XSL.

A Select Form has two combo boxes: Data Component and Element. The Data Component combo box lists the components selected for the Data Event for this form. The Element combo lists the elements for the XML, returned by the above selected Data Component. Selecting the element from this combo indicates to the XSL generating logic to generate a structure of this form:

<xsl:for-each select=“[. . .]//Element”>List Text </xsl:for-each>

The List Text edit box indicates the repeating text. This can contain variables previously defined within the application, Directory information, or dynamic data as retrieved from the Data Components. Since, a form can have multiple data components, the user is forced to select a single element within that single data component to iterate on. Also, we enforce that once the element has been selected, all the information to be displayed in a single row be present in either its attributes or the data values of its direct children. In essence, the user is restricted to a flat structure under the selected element. This limitation is mainly because of the UI and can be eased in future revisions of the UI. However, the user would be allowed to reference specific elements or attributes from the XML from other Data Components.

The following are internal steps to take data that has been brought down from any source and produce a UI to let users create XSL patterns/XPaths.

[1] GetXML Data
<moreovernews>

<article id=“5109392”>

<url>http: //d.moreover.com/click/here.pl?x5109387</url>
<headline_text>Japan: Govt to set standards for GM food

labeling</headline_text>

<source>Daily Yomiuri</source>
<media_type>text</media_type>
<cluster>Biotech news</cluster>
<tagline>Japan</tagline>

<document_url>http: //www.yomiuri.co.jp/main/maine.htm</do
cument_url>

<harvest_time>Jan 8 2000 7:09 PM</harvest_time>
<access_registration />
<access_status />
</article>
</moreovernews>

[2] Transform XML to Determine Element and Attribute Structure Metadata

[2.1] Here is the Transformation Stylesheet

<xsl :stylesheet xmlns:xsl=‘http://www.w3.org/TR/WD-xsl’>
<xsl :template match=‘/’>
<xsl :element name=‘NodeSet’>

<xsl :apply-templates/>

</xsl :element>
</xsl :template>
<xsl :template match=‘*’>
<xsl :element name=‘Element’>

<xsl :attribute

name=‘XPath’><xsl :eval>getPath (this) </xsl :eval></xsl :attr
ibute>

<xsl :attribute

name=‘Name’><xsl :eval>nodeName</xsl :eval></xsl :attribute>

<xsl :attribute

name=‘Type’><xsl :eval>nodeType</xsl :eval></xsl :attribute>

<xsl :attribute

name=‘Depth’><xsl :eval>depth (this) </xsl :eval></xsl :attrib
ute>
</xsl :element>

<xsl :apply-templates select=‘* | @*’/>

</xsl :template>
xsl :template match=‘@*’>
<xsl :element name=‘Element’>

<xsl :attribute

name=‘XPath’><xsl :eval>getAttrPath () </xsl :eval></xsl :attr
ibute>

<xsl :attribute

name=‘Name’><xsl :eval>nodeName</xsl :eval></xsl :attribute>

<xsl :attribute

name=‘Type’><xsl :eval>nodeType</xsl :eval></xsl :attribute>

<xsl :attribute

name=‘Depth’><xsl :eval>depth (this) </xsl :eval></xsl :attrib
ute>
</xsl :element>
</xsl :template>
<xsl :script>
<! [CDATA [
function getAttrPath ()
{

var strResult;
strResult = getPath (this.selectSingleNode (‘..’)) +

“/@” + nodeName;

return strResult;

}
function getPath (e)
{

var strXPath;
strXPath = “/” + e.nodeName;
// Stop when the parent is the document root (node

type 9)

if ( 9 != e.parentNode.nodeType )

strXPath = getPath (e.parentNode) + strXPath;

return strXPath;

}
]]>
</xsl :script>
</xsl :stylesheet>

[2.2] Here is Resulting Output After Transforming Data in [1], After Sorting and Eliminating Duplicates

<NodeSet>

| | | |
|---|---|---|
| <Element | XPath=“/moreovernews” | Name=“moreovernews” |

Type=“1” Depth=“1” />

| | | |
|---|---|---|
| <Element | XPath=“/moreovernews/article” | Name=“article” |

Type=“1” Depth=“2” />

| | | |
|---|---|---|
| <Element | XPath=“/moreovernews/article/@id” | Name=“id” |

Type=“2” Depth=“3” />
<Element
XPath=“/moreovernews/article/access_registration”
Name=“access_registration” Type=“1” Depth=“3” />

| | |
|---|---|
| <Element | XPath=“/moreovernews/article/access_status” |

Name=“access_status” Type=“1” Depth=“3” />

| | |
|---|---|
| <Element | XPath=“/moreovernews/article/cluster” |

Name=“cluster” Type=“1” Depth=“3” />

| | |
|---|---|
| <Element | XPath=“/moreovernews/article/document_url” |

Name=“document_url” Type=“1” Depth=“3” />

| | |
|---|---|
| <Element | XPath=“/moreovernews/article/harvest_time” |

Name=“harvest_time” Type=“1” Depth=“3” />

| | |
|---|---|
| <Element | XPath=“/moreovernews/article/headline_text” |

Name=“headline_text” Type=“1” Depth=“3” />

| | |
|---|---|
| <Element | XPath=“/moreovernews/article/media_type” |

Name=“media_type” Type=“1” Depth=“3” />

| | |
|---|---|
| <Element | XPath=“/moreovernews/article/source” |

Name=“source” Type=“1” Depth=“3” />

| | |
|---|---|
| <Element | XPath=“/moreovernews/article/tagline” |

Name=“tagline” Type=“1” Depth=“3” />

| | | |
|---|---|---|
| <Element | XPath=“/moreovernews/article/url” | Name=“url” |

Type=“1” Depth=“3” />
</NodeSet>

[3] Generate Internal Data Structure for Context Menu Generation

Legend

[M]=Submenu entry—subsequent entries will be in a submenu

[N]=Normal menu entry

[S]=Menu Separator—for visually grouping related items

[E]=End of menu—this does not produce visible entry, but causes subsequent entries to be in the parent menu

Notes:

Data Structure entries are indented for easier visualization

Each item entry also includes the XPath expression in order to produce the output token

[3.1] For Elements and Attributes

[M] moreovernews

[N] TEXT
[S]
[M] article

[N] TEXT
[S]
[N] @id
[S]
[N] access_registration
[N] access_status
[N] cluster
[N] document_url
[N] harvest_time
[N] headline_text
[N] media_type
[N] source
[N] tagline
[N] url
[E]

[E]

[E]

[3.2] For Elements Only

[N] moreovernews
[M] More...

[N] article
[M] More...

[N] access_registration
[N] access_status
[N] cluster
[N] document_url
[N] harvest_time
[N] headline_text
[N] media_type
[N] source
[N] tagline
[N] url
[E]

[E]

[E]

[4] Data Subset Display

A subset of nodes can also be displayed, depending on an arbitrarily selected root node. The output is identical to that in section [3], except that internally the XPath expression stored is relative to the selected root node. For example, if the user selected “article” as the root node, the resulting relative XPaths would apply:

<Element XPath=“.” Name=“article” Type=“1” Depth=“2” />
<Element XPath=“./@id” Name=“id” Type=“2” Depth=“3” />

| | |
|---|---|
| <Element | XPath=“./access_registration” |

Name=“access_registration” Type=“1” Depth=“3” />

| | | |
|---|---|---|
| <Element | XPath=“./access_status” | Name=“access_status” |

Type=“1” Depth=“3” />
...

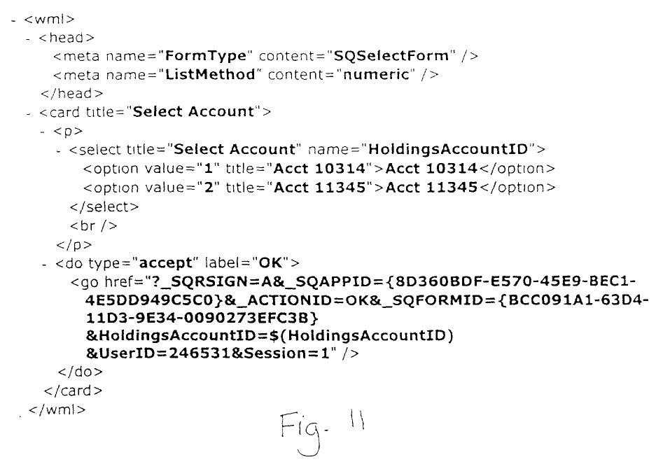

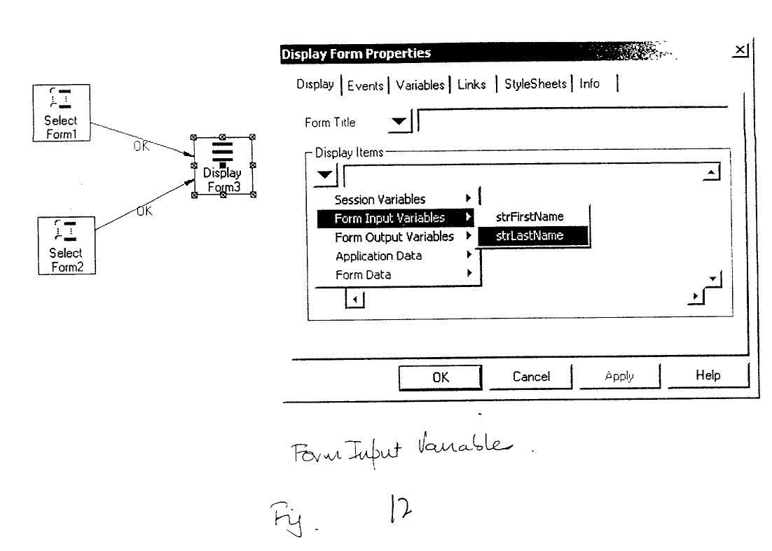

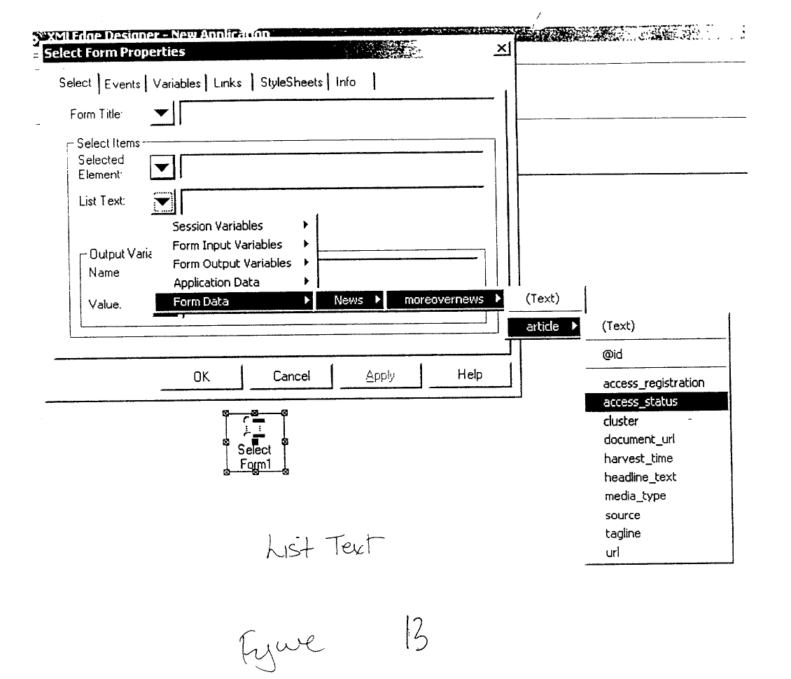

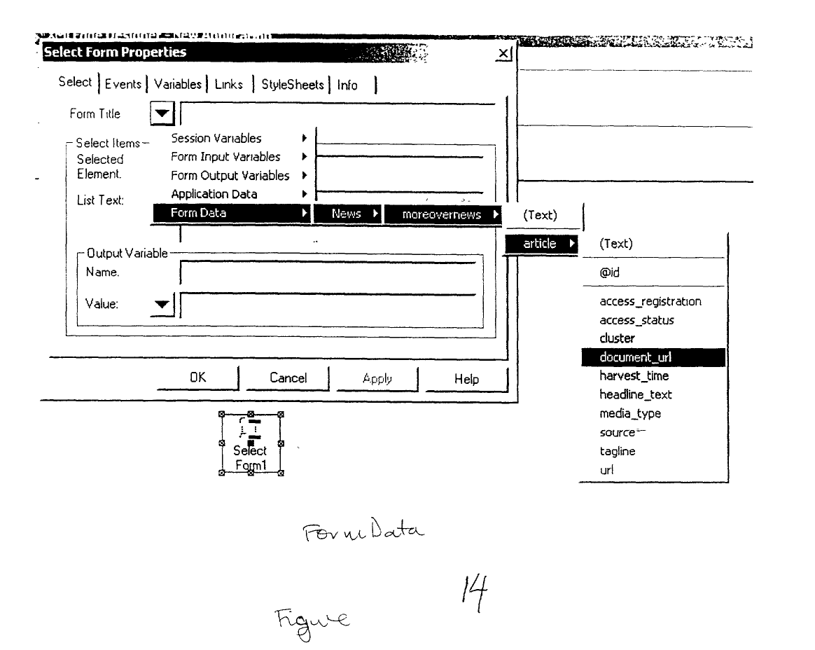

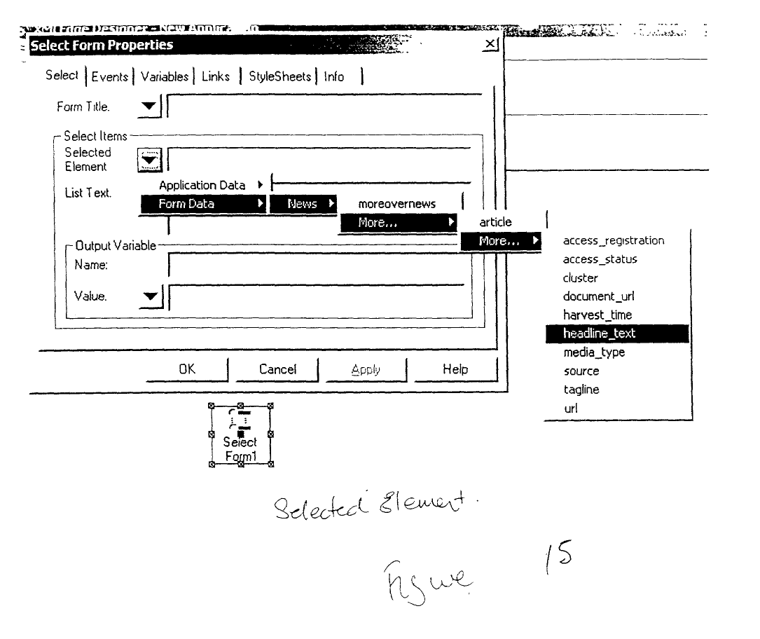

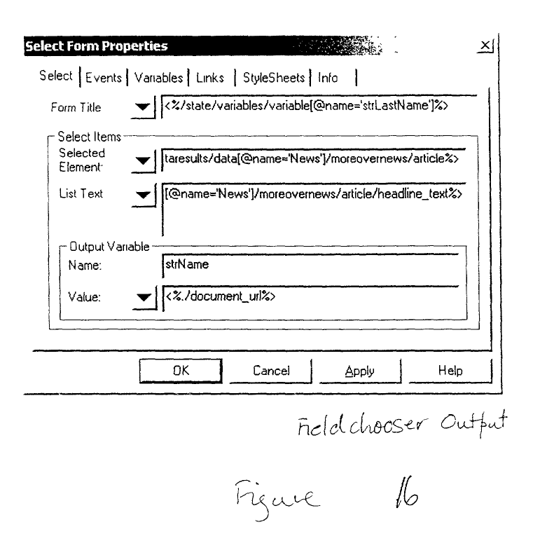

FIGS. 12 to 16 are screen shots of a graphical representation of the above algorithm. The use of a Field Chooser (FC) from the Select Form property page is illustrated. Note the “before” screen FIGS. 12 to 15 using the field chooser and the “after” screen, FIG. 16 of the XPath it generates. Also notice that the “form data” section of the field chooser is used. In this case it only shows elements and does not show any attributes since it is being used to get a list of elements. This enables one to do an xsl:for-each loop on a page that has a listing. The “selected element” section of the FC is showing relative XSL paths related to the chosen “selected element” in this case. In the complete view with attributes, “(text)” refers to actually getting the text of the node whereas clicking on the name of the element will generally expand to all sub-elements and attributes. This is key since an element could have text, attributes, and sub-elements. Attributes are shown with a @ in front of the name. If an element has no attributes or sub-elements we don't display a submenu and clicking on it simply returns the text. Much of the complexity in the FC is understanding that to show schemas you need to show several views:

1) All attributers and elements

2) Only elements

3) Relative paths of elements and attributes from a selected element.

Accordingly, it may be seen that the design tool or field chooser allows for the display of a top level menu of types; shows within each level all the appropriate schemas; recursively traverses the schema information to build cascading menus or toolbars; for each element shows all attributes; when the programmer selects a level it builds a fully qualified path or relative path based on XSL patterns; works with DTD, XML—schema or evolving schema definitions, and finally provides namespace management.

Although the invention has been described with reference to certain specific embodiments, various modifications thereof will be apparent to those skilled in the art without departing from the spirit and scope of the invention as outlined in the claims appended hereto.

The embodiments of the invention in which an exclusive property or privilege is claimed are defined as follows:

1. A method for building a web-based application comprising:
(a) displaying a top level menu of types;
(b) showing within each level appropriate schemas;
(c) recursively traversing the schema information to build cascading menus or toolbars;
(d) showing for each element all attributes; and
(e) building a fully qualified path or relative path based on XSL patterns when a programmer selects a level.
